(19) United States
(12) Patent Application Publication
(10) Pub. No.: US 2015/0236904 A1
(43) Pub. Date: Aug. 20, 2015

(54) Internet Device Architecture to Save Power And Cost

(71) Applicant: Hsiaokuei Tsui, Pingtung City (TW)

(72) Inventor: Hsiaokuei Tsui, Pingtung City (TW)

(21) Appl. No.: 14/702,758

(22) Filed: May 3, 2015

Related U.S. Application Data
(60) Provisional application No. 62/006,265, filed on Jun. 2, 2014.
(60) Provisional application No. 62/038,366, filed on Aug. 18, 2014.

(51) Int. Cl. H04L 12/24; H04L 29/08

(52) U.S. Cl. CPC H04L 41/0806; H04L 67/10

(57) ABSTRACT

Embodiments of the invention provide a processorless state-machine based system-on-chip solution for a network device to transfer data across Internet or a large network. The data communication part of the network device can be compromised to use much simpler protocols. However, an Internet device requires configurations to communicate properly. Such configurations in a commercially available device need to come from other node on the network by an automatic configuration protocol and such configuration communication part has to be implemented processorlessly too. The overall result is a chip for an Internet device that saves power and cost by eliminating components for a processor system. It is particularly useful in Internet-of-Thing applications and for hooking up appliances and sensors to Internet.

### CROSS-REFERENCE TO RELATED APPLICATIONS

This application claims the benefit of provisional patent application Ser. Nos. 62/006,265 and 62/038,366, filed Jun. 2, 2014 and Aug. 18, 2014 respectively, by the present inventor.

### BACKGROUND

People have been using hardware finite state machine (FSM) to implement communication protocols for long long time. In fact, ever since digital communication protocol emerged, there must have been some of the protocols (particularly in lower layers) in hardware FSM, because any software implementation requires processors or microprocessors (or alternatively named CPUs, MCUs, micro-controllers, etc), and processors may not be fast enough or not be convenient for certain operations (like handling raw bit data). The earliest patent literature for implementing communication protocol in this hardware method I could find is U.S. Pat. No. 3,457,550 in 1967.

Computer bus protocols share many similarities with communication protocols. So the history of using hardware FSM to implement protocols could trace back to the earlier of either computer bus or digital communication.

For such long time, people also have realized the benefits of using hardware FSM for protocols. Such benefits are like high speed, low power dissipation, dedicated unit for responding, and potentially low cost.

Since Internet is so prevailing, it would have been natural that people would propose using hardware FSM for more protocols of Internet. Some have proposed TCP offload, offloading some TCP processing work from processors to dedicated FSM. Cone et al. from Intel Corporation proposed a general hardware method architecture for processing network protocols in their 2000 application U.S. Ser. No. 09/742,264, while still expected separate network adapter and application appliance in their architecture. For past 40-year of Internet history, none had proposed a single chip (a single piece of integrated circuit or IC using semiconductor as substrate material where localized electrical properties can be controlled by fabrication to make various tiny electronic components like transistors, resistors, capacitors, connectors etc. to form desired electronic circuit) architecture with pure hardware FSM method (i.e. all the protocols processing from physical layer to the application layer and application providing are handled by hardware FSM and no processor involved) doing everything from connecting to Internet to providing applications, even though people have realized benefits of using hardware FSM.

I identified two difficulties in implementing such pure hardware FSM Internet devices:

1. Applications for modern Internet devices get more and more complicated. For example, text-based e-mail becomes multi-media form, simple text-based HTML is replaced by picture- or video-rich interactive web pages, etc.
2. The overall complexity of Internet, from physical layer to application layer, is very high. Internet was originally designed for “smart” end devices (a network end device is a device on the network end; it is either the source or the destination of a message and need to communicate to other network node outside its local subnetwork through at least one intermediary node). It can communicate over variety of physical and link layers and has been able to scale throughout past 40 years for even today's multi-billion-user network. So the end device has to have certain complexity.

With the emerging of Internet-of-thing (IoT) devices, the first difficulty was solved. There will be Internet devices doing no more complicated work but only simple tasks like switching light on or off, controlling temperature setting of air conditioners, or moving sensor data back to the requestors, etc.

The embodiments of this invention try to address the second difficulty. Internet protocols can be separated into 5 layers, from physical layer to application layer, with vastly different electrical properties and purposes. On each layer, there are a few to a few dozen communication protocols. Each has various options and usages. That is already complicated enough; but nowadays electronic devices are mostly centered on silicon-based IC. Many improvements need to take advantage of the silicon or semiconductor properties. Currently any IC design and fabrication activity takes millions of US dollars. With all the complexity and issues, it is hard to see the forest for the trees and find any improvement.

People can always implement the full set of Internet protocols in hardware FSM. However, even though that is theoretically possible, the implementation will be monstrous in gate count or silicon die size. That won't save any cost or power at all. Also, such complexity will require lengthy and costly ASIC design cycle. As mentioned earlier, Internet was originally designed for smart end devices. For such “dump” IoT end devices, it should not do too much more than just moving data. Fancy features of the Internet (or “frilled” protocol services as some people said) should be evaluated carefully and only be included if they are absolutely necessary.

As essential parts are identified and implemented in hardware FSM, combined with analog and RF circuitry wherever possible, in a single chip fashion, I can have a system on a chip that both saves power and reduces cost.

Particularly, low power and low cost are the two main design goals for IoT devices.

Nowadays low-power Bluetooth or Zigbee devices work fine in power dissipation. They may be able to operate days or months without charge, depending on usage pattern and battery size. However, it is a forever need to save even more power. Just some fractions of power saving for the whole device (not just for the IC) can be very significant result, enough to use lighter battery for portable, wearable, medical or in-air “drone” devices, or to enable creative energy sources like solar, body movement, or fruit energy, etc.

In addition, if the cost for the whole device can be reduced by some percents, that is very significant too. IoT devices are in large volume low cost product segment. Cost saving can be the key to wide and successful adoption of IoT devices.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 shows a prior art device architecture

FIG. 2 shows a possible embodiment

FIG. 3 shows a possible embodiment with wirelined ethernet

FIG. 4 shows a possible packet process flow

FIG. 5 shows frame structure for ICMPv6 over IPv6 over ethernet

FIG. 6 shows frame structure for application data over UDP over IPv6 over ethernet for a possible embodiment

FIG. 7 shows a possible packet process flow

FIG. 8 shows a possible embodiment for wireless network

FIG. 9 shows a possible process flow for an embodiment

FIG. 10 illustratively shows end-to-end reliability of TCP

### DETAIL DESCRIPTION

### Comparing Software and Hardware Implementations of a Protocol

In the following description, some specific details are provided, to provide a thorough understanding of embodiments of the invention. A person having ordinary skill in the art (PHOSITA) will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. In this application, when “Internet” is mentioned, it may mean not just the Internet but also a large network with hundreds or more of nodes. Also, when “silicon” is mentioned, it may mean any semiconductor material for building an integrated circuit.

FSM is a mathematical model of sequence of events, in which next event depends on current event and current inputs. If I detail the relationship between current event, current inputs and next event for all events, I can have a full description of the FSM. Such description can be in a state transition table or a state transition diagram.

I can then implement such FSM description in software as instructions or programs run on a processor system. But in this application I am mainly concerned about implementing FSM in hardware, so the embodiments can have no processor. In this application, if FSM is mentioned without referring to hardware or software implementations, or merely hardware method is mentioned, it is meant implementing in hardware FSM. Because most digital circuits have state information, I may refer a digital circuit, with or without states, as a FSM.

A protocol is a predefined set of rules that determine how data is transmitted and received on a computer bus, in computer network or telecommunication. It may include several packets exchanged in transmit (TX), receive (RX), or both directions (for example, a regular DHCPv4 protocol includes exchanging four packets in TX-RX-TX-RX order). After passing analog-to-digital converter, a protocol becomes pure digital operations. Such digital operations can be implemented by in FSM by hardware or by software, as mentioned. Since this application is mainly concerned with protocols for computer network and telecommunication, I refer these protocols collectively as communication protocols.

Below I briefly compare implementing a protocol in software (run on a processor system) and hardware.

Structure

Major components of a processor are datapath and control logic. The datapath, whose purpose is manipulating data, is composed of ALU (Arithmetic and Logic Unit) and register file. The core part of the ALU is adders, which commonly have width of 8, 16, 32, or 64-bits. The control logic is to fetch instructions, sequencing the instructions according to both the current instruction and results from datapath. The way datapath manipulating data is the ALU doing the arithmetic or logic operation through its adders depending on instructions fetched by control logic. There is also additional memory needed to store instructions and data for reasonably practical use, and memory fetch logic. The processor also needs host buses to communicate to the outside world. All these components are implemented by logic gates (while the memory may be in a special type of logic gates) and eventually in transistors in silicon. PHOSITA can understand a processor system take quite a few of logic gates, or quite a few of transistors, or quite a bit of silicon area, even for a simple task. Such silicon area or “die size” is a rough estimation of the cost. There are also a lot of digital gate switchings or transistor switchings (thus the dynamic power, the major part of power dissipation) throughout above identified components, even for a simple task.

FSM uses a few registers or storage elements for state encoding. It also has some combinational logic for implementing state transition, converting inputs to desired forms, converting states and inputs to desired outputs. These registers and combinational logic are implemented in gates, then in transistors, eventually in silicon. PHOSITA can understand for simple tasks, FSM implementation should use fewer gates, fewer transistors, or less silicon area. The power dissipation is mostly limited to the related digital gates that make voltage transitions only.

Some people may use counters to orchestra all or part of the events, instead of using FSM explicitly; in fact, counters belong to FSM too since counters are a few registers with a few combinational logic in between the registers. But even though processors have storage elements and combinational logic is in between the storage elements, it is not a FSM. PHOSITA can easily distinguish the two; a processor has ALU in its internal structure, takes instruction from memory, and executes the instruction on ALU. Implementing tasks in a processor system require writing software or programs, which will be stored in the memory; while implementing in FSM is like drawing state transition diagrams or tables and the circuit will finally be in hardware.

An implementation method implements the digital portion (including FSM) of the IC from a few fixed building blocks. These building blocks can be, for example, AND, NAND, NOR, OR, Invert, register element or any combinations of them. They are selected according to desired functions, mapped into silicon layout, and then properly routed. Any of above selecting, mapping and routing steps can be done manually, by computer, or both. The mapped and routed layout for digital part then properly combines with clock trees, analog, RF transceiver and chip pad mappings. The overall layout is then sent to a semiconductor manufacturing company or division to manufacture the IC. This is ASIC (Application Specific IC) method.

Another implementing method can use pre-manufactured IC with field programmable building blocks. These are like those available in FPGA, CPLD, PLA, or any other programmable logic, to implement the FSM too. This is programmable logic method.

People can implement all the components for an electronic circuit of a device with many discrete units. However, today electronic components are mostly or can be made in silicon. Integrating as many as possible the electronic components in a single piece of silicon as single chip form in ASIC method offers cost advantage for large volume products, since that saves packaging, wiring and processing costs. The single chip form also can reduce power and overall device size. Such advantage is especially prominent if all the digital operations plus as many as possible analog functions are integrated into a single chip. Since in this application almost all operations of embodiment devices are integrated in a single chip, I may refer to the chip as the device.

Functioning

The software method is good at working on long and complicated functions. People can write long programs fairly easily, store them as instructions in the memory and let the processor execute it. It is able to finish a task as long as the memory is big enough to store all the instructions and the processor has enough processing power (usually means the clock need to be fast enough and the processor has less idling cycles). Instructions stored in memory have memory addresses, so it is easy to branch or jump to a particular memory address to start a new sequence of instructions depending on conditions, like subroutines called by conditional instructions or interrupts. If a processor system wants to use an operation multiple times, the same operation code will appear multiple times in the instruction list. An example is like a program having multiple “ADD” operation codes.

FSM is usually designed by State Transition Diagram, State Transition Table, or Algorithmic State Machine method. For long, complicated tasks, it becomes a bit hard to design and verify the FSM, in some sense it is because a lot of states are needed and interaction of the states becomes a lot more involved. It does branching by designing new sequence of states. If an operation needs to re-use multiple times, it needs separate hardware for each invocation of the operation, or some “re-use” logic is needed.

Comparison Conclusion

Above conforms to common knowledge that hardware method is more suitable for parallel type operations like Linear Feedback Shift Register and CRC calculation, etc. It is commonly in lower layers, or the protocol designers intentionally designed that way. Software method is better suited for long and sequential type operations, typically in the upper layers. But this is not a golden rule people can't break, as long as the overall system possesses certain benefits.

If I can reduce the sequential part or complexity of system operation, for cost, the hardware method will have smaller die size than that of the software method, since the processor has some almost “fixed” overhead like ALU, register file, control logic, memory, host bus, etc, while die size for the hardware method is almost like growing proportionally with the complexity.

For power, the hardware method always consume less dynamic power, in some sense it is because only necessary digital gate or transistor switchings in hardware method while there are a lot of transistor switchings related to the above identified processor components (ALU, register file, control logic, memory, host bus, etc) using software method. Sometimes software method even needs to iterate multiple times for a one-step operation in hardware method (like CRC, wide-width data, etc). While static power is the major component in CMOS power dissipation, if the IC is very big, other components of power dissipation (like static power) may kick in.

So it is desirable to simplify the task so I can take advantage of the hardware method to save both power and cost. Internet can indeed operate in some modes with only primitive protocols to just move the data around. But to have practical use, is there any fancy feature necessary, besides just moving data around?

### DETAIL DESCRIPTION

### Fancy Features

There are a lot of fancy features throughout the 5 layers for Internet end devices. I use congestion control to illustrate impacts of such fancy features on implementations. Congestion control detects some network congestion indicators (delay, packet loss, etc) feedbacked from the other communication party through RX side and throttle TX side traffic accordingly. In software method, when any of such indicators is received and pass predefined thresholds, the program can jump to a subroutine (instruction pointer of the processor move to a new memory location) to handle that condition. So, as long as memory is large enough and the processor has enough processing power, which is usually the case, it is not a problem. But in hardware method, this behavior (detecting some RX indicators and changing TX behavior) effectively adds new sequence of states. The extra sequence of states taxes pretty good extra die size and power.

Another example is like ping and trace route features of Internet Control Message Protocol (ICMP). If these fancy features are not really required, they should not be implemented.

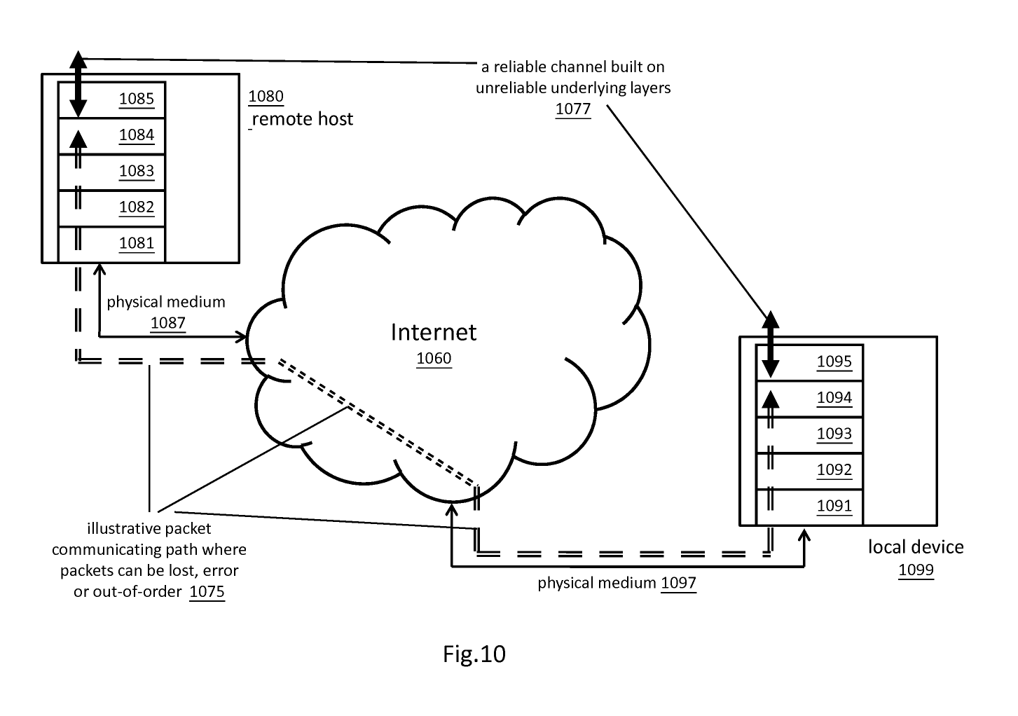

Transmission Control Protocol (TCP) is one of the most complicated protocols. Even pipelined, congestion control and flow control features of TCP can possibly be disabled, against Internet authority organization's requirements, the end-to-end reliability feature of TCP alone is still huge. Relative position of TCP end-to-end reliability to the whole Internet protocol architecture is illustratively shown in FIG. 10. End-to-end reliability means, although underlying protocols 1091/1092/1093 1081/1082/1083 and path 1075 can be unreliable (lose packets, receive error bits in packets, or re-order packets), a protocol on top of them 1094/1084 can furnish a mechanism to provide a reliable channel for upper layer 1095/1085, where packets delivered correctly and orderly between the two end hosts 1080/1099 of the communicating path through network. It utilizes feedback control mechanism to implement the channel and such reliable channel either works or breaks (if it can't deliver packets reliably). Such mechanism is called Automatic Repeat reQuest (ARQ) in computer network. The end-to-end reliability of TCP requires a 32-bit random number chosen at initialization on both ends, communicating that number, adding packet size of every packet to that number, and using the resulting number to detect any lost packet. Whenever lost packet is detected, there is also a set of procedures to ask the sender to re-send. Obviously the whole process is dauntingly complicated for the hardware method and without much gain for IoT-type devices. This end-to-end reliable feature, if needed, can always be compromised with other means and let the much-smarter remote host do most of the work. So some embodiments of the invention will use UDP (User Datagram Protocol), instead of TCP. When the signal path is noisy, TCP channel may break without any connection at all just due to it can't deliver packets reliably, but UDP may still have some connectivity, which is not a bad feature for IoT-type devices.

Also think from the other side of the problem. Even if the software method is used, TCP will require a bit of processing power and a simple processor won't do it. The processor needs to be powerful enough to handle TCP, which means at some sacrifice of cost and power.

For wireless link on the link layer, there is usually reliability feature associated for the link, but it is much simpler and more flexible. I will discuss it in the Third Embodiment section.

Any network device needs to be configured with proper network address and settings to start communicating on a network. A network address is a unique identifier on the network for the device so messages can be routed properly. Network settings are some network configuration variables other than network address and with which a network device can properly communicate on the network; examples like hop limit, MTU (Maximum Transmit Unit) size on Network Layer, SSID for IEEE 802.11 Link Layer, etc. Herein I use the term “network parameters” for both network address and settings collectively. Also, the terms of network parameters, network device and network address etc are not limited to merely “network layer”; they just mean parameters, apparatus, address of a “networked” device.

Some network parameters can be derived completely locally; example like link layer address. Some network parameters need some interactions with other nodes on the same network in order to obtain them. These network parameters may be related to the particular nature or structure of network, the environment of the network, etc. They are controlled by variables outside of the device so the device has no way to derive such network parameters by itself and it needs to get such network parameters from other device. If the way passing such network parameters is one-way communication, it can be done in physical or link layer; for example, voltage level of a wire indicating an operating mode; wireless IDs extracted by tuning in the particular frequency of the channel. If passing network parameters requires two-way communication and the channel is a point-to-point link, some physical or link layer trick can be used, like auto negotiation of ethernet (where limited two-way data transfer is possible). Above two methods are in link and physical layers and have been traditionally implemented in hardware.

If passing network parameters requires two-way communication and the link is non-point-to-point, the device needs to compete with other devices to access the channel, thus it requires channel access mechanism. Since channel access is a link layer function, the more general way of passing network parameters (works for point-to-point and non-point-to-point link) is using automatic configuration above link layer.

Automatic configuration protocols are protocols that either explicitly convey network parameters from a node on the network to the device or implicitly direct the device for such network parameters. Those automatic configuration protocols above link layer have been traditionally done by software. If I want to use pure hardware method, I need to implement all ways of passing network parameters in hardware, including those automatic configuration protocols traditionally implemented in software. For this application, automatic configuration protocols also belong to communication protocols, since they are used to convey network parameters and are part of communication protocol suite.

Not many years ago people still used to configure their network devices manually and that certainly required lots of cares and expertise. Today people are already used to the convenience of automatic configuration. In the future, there will be many IoT devices around our living, and such automatic configuration ability will certainly become a must.

So embodiments of the invention will include automatic configuration capabilities. The automatic configuration protocols may be standardized; examples include Dynamic Host Configuration Protocol (DHCP) for IPv4/IPv6, IPCP for PPP protocol, IPv6 Neighbor Discovery and Stateless Address Autoconfiguration.

The automatic configuration protocols can also be proprietary (non-standardized). If I have a centralized configuration server that knows network parameters for the device and the device agrees to the proprietary protocol, I can use the proprietary automatic configuration protocol to configure the device. One of the benefits for such embodiments is the device can do the simple part of the configuration while the hard part of configuration, like parameter determination, address confirmation, application parameter programming, etc., is left to the centralized configuration server. The centralized configuration server may even act like an agent for the device to reply standardized queries on behalf of the device. The underlying principal for proprietary automatic configuration protocols is the same as standardized ones. A network device uses such protocols to contact automatic configuration server(s) on the network. It indicates its need for network parameters and provides some of its identification. Upon receiving the request, the automatic configuration server(s) uses the device's identification to figure out a set of parameters and then uses the protocol to send the parameters back to the device. The network device then uses the retrieved parameters to configure itself.

### DETAIL DESCRIPTION

### First Embodiment

Detail of communication protocols and how they are implemented in hardware method are well documented on various textbooks and publications in computer network and VLSI design fields. Starting from this section I provide several possible embodiments of the invention. Embodiments may use standardized protocol specifications and PHOSITA can reference to such specifications from standard bodies or Request For Comments (RFC) for such details.

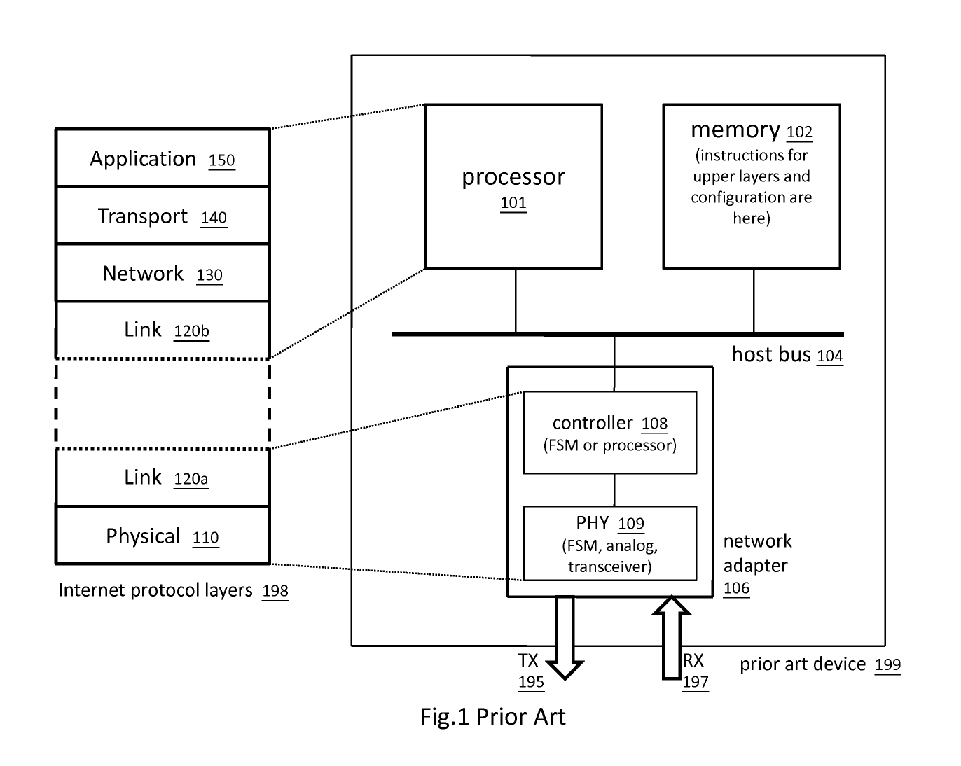

FIG. 1 shows architecture of a typical prior art device with respect to Internet protocols layering. Internet separates protocols into 5 layers: physical 110, link 120a/120b, network 130, transport 140 and application 150 layers. In this prior art architecture, processor 101 does most of the processing and control work for the device. The processor 101 communicates to the outside world, including memory 102 and network adapter 106 through host bus 104. The memory 102 keeps instructions and data for the processor 101. The instructions the memory 102 keeps include how to handle protocols for upper layers 120b/130/140/150, some controls for the network adapter 106 or lower layers 110/120a, and how to process applications (for example, render a html file to be displayed on a monitor). The memory 102 also keeps network parameters and instructions to get those network parameters, by automatic configuration protocols or by other methods (like predefined addresses). The network adapter 106 typically includes a PHY 109 and a controller 108. The PHY 109 interfaces directly to physical medium. It converts signals in the physical medium to a form suitable for processing by latter units. The PHY 109 can have wide variety of structures, depending on different physical mediums. For wirelined communication, the physical mediums can be optical fiber, copper wire, coaxial cable, etc. For wireless communication, the physical mediums can be air, vacuum, water, etc. PHY 109 generally includes digital circuit (for digital coding and control; can be FSM if state info required), analog circuit and transceiver. The controller 108 does functions of lower link layer 120a, including channel access, frame validation, association and disassociation. In some prior art the controller 108 is composed of FSM, while some may include another processor or a mixture of processor and FSM.

In this prior art device and in the embodiments discussed later, there are also two common actions in each layer: taking data from the upper layer, encapsulating the data according to the protocol rules, providing encapsulated data for lower layer in TX 195 direction, and taking data from the lower layer, decapsulating packet, extracting the data for upper layer in RX 197 direction. I will call the two actions as multiplexing and demultiplexing, or denote them as mux/demux for short.

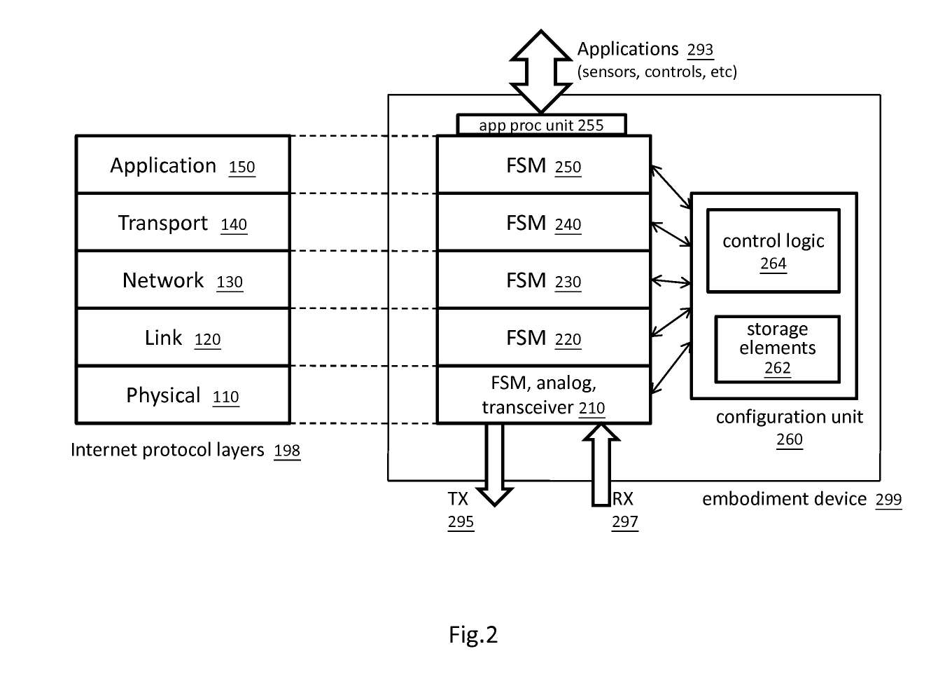

A more general architecture of embodiments of the invention, as shown in FIG. 2, replaces the processor 101, memory 102, and the host bus 104 of FIG. 1 with FSM, so all the digital operations are done by FSM. The digital operations of providing applications 255, processing protocols in application 250, transport 240, network 230, link 220, physical 210 layers, and configuring 260 are handled by FSM. There is no processor in the architecture.

The configuration unit 260 includes storage elements 262 and control logic 264. The storage elements 262 can be very small in volume, just need to be big enough to keep all the network parameters. Some part of the storage elements 262 can be non-volatile for storing permanent data (like device identifier) or optionally semi-permanent data (like last good set of parameters before power off). Implementation of this storage elements 262 can be embedded flash memory or EEPROM (Electrically Erasable Programmable Read-Only Memory), embedded RAM (Random access Memory) combined with hardwired pins or laser-fused wires for the device identifier, or any other methods known to PHOSITA. The control logic 264 provides all the configuration related operations, including transmitting and receiving configuration frames for automatic configuration protocols, writing to storage elements 262.

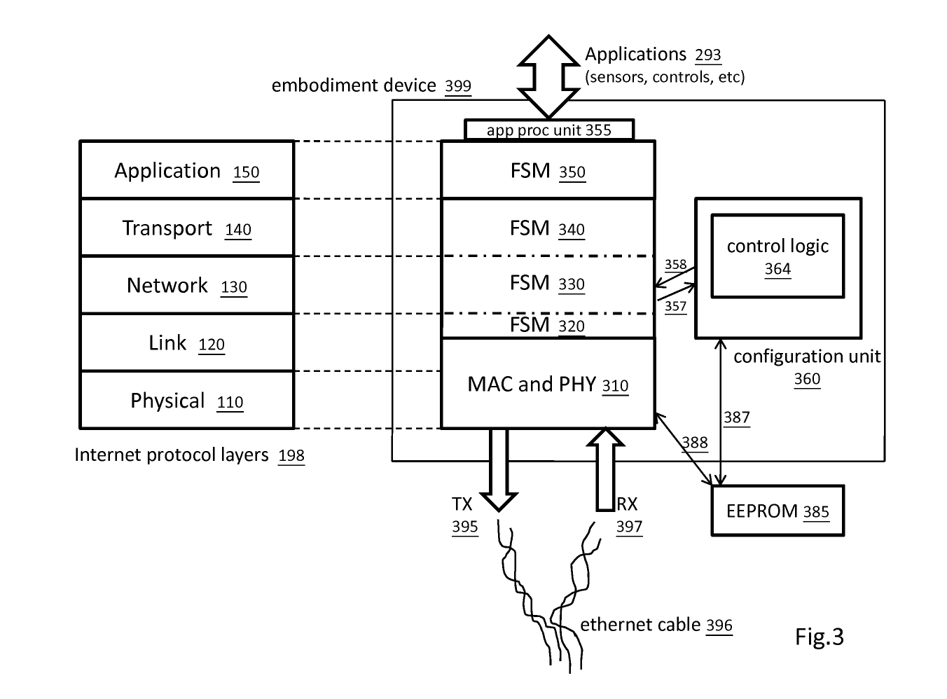

FIG. 3 shows the embodiment I will discuss in this and next section. Here I assume wirelined Ethernet, the common 100BASE-TX or 10BASE-T, is used for physical and most of link layer. There are already a lot of FSM-based Ethernet “single-chip” (single chip of “network adapter” 106) ICs on the market, like LAN9115 from Microchip Technology Inc, CP2200 from Silicon Labs and RTL8100C from Realtek Inc. They were designed from well-documented ethernet standards and these products are well-documented in their datasheets. PHOSITA can reference such documentations and readily knows how to make and use those parts. I suppose I can leverage one in this embodiment device shown as block 310 for the purpose that I can just demonstrate the idea of embodiments of the invention and readers won't get distracted by the complicated operations inside MAC and PHY.

Such MAC and PHY usually require an external EEPROM to store MAC address, so I use one as 385. Since the configuration unit 360 may need information inside the EEPROM 385, I also show a separate access channel 387. But readers are reminded that the control and configuration part of MAC and PHY 310 can be merged with configuration unit 360, the access channels 387/388 for EEPROM 385 can actually be just single one, and the EEPROM 385 can be embedded as storage elements 262 shown in FIG. 2 or of other forms.

I also assume IPv6 for network layer 330 and UDP for transport layer 340. In such situation, the only network parameters I need are network layer (IPv6) address and some network layer settings. They are all in network layer and conveyed by automatic configuration protocols in network layer. This case is illustrated in FIG. 3: there are only an arrow 357 from network layer FSM 330 to configuration unit 360 and another arrow 358 in the reversed direction. On the contrary, FIG. 2 uses dual-headed arrows between each layer 210/220/230/240/250 and configuration unit 260, illustrating a more general but still possible case that each layer needs configuration from configuration unit (260) and each layer provide information for the configuration unit (260) for setting network parameters kept in storage elements (262).

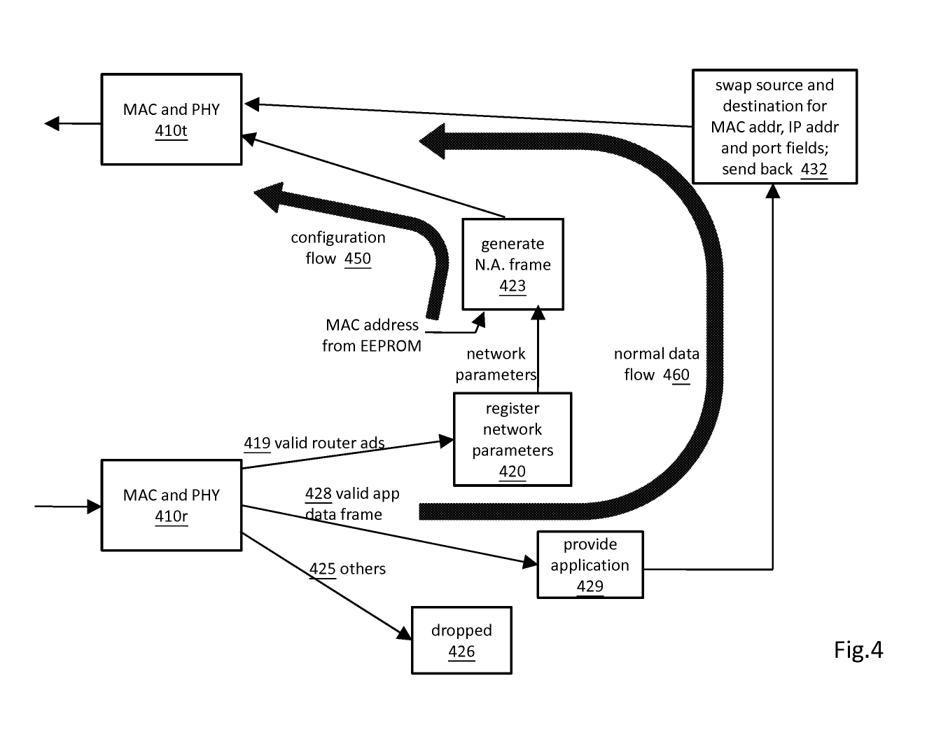

In this First Embodiment I assume IPv6 Stateless Address Autoconfiguration is used to get such network parameters. In Second Embodiment next section, I assume IPv6 DHCP rapid commit is used to retrieve such network parameters. In both cases I suppose the IP addresses are guaranteed globally unique so no duplicate address detection mechanism is needed. Packet process flow chart for First Embodiment is shown in FIG. 4. There are two kinds of packet flows: one for configuration flow 450 and the other for normal data flow 460. Below I discuss these two kinds of packet flows:

Configuration Flow 450

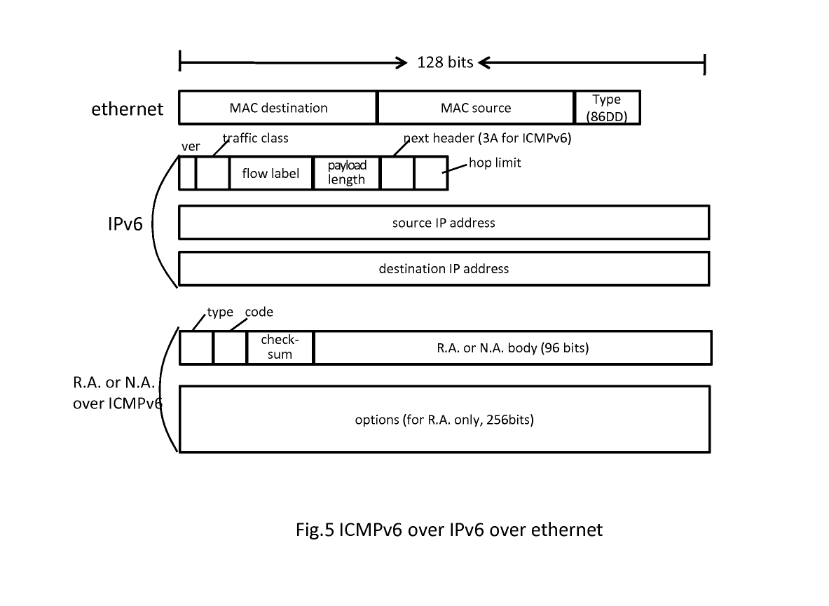

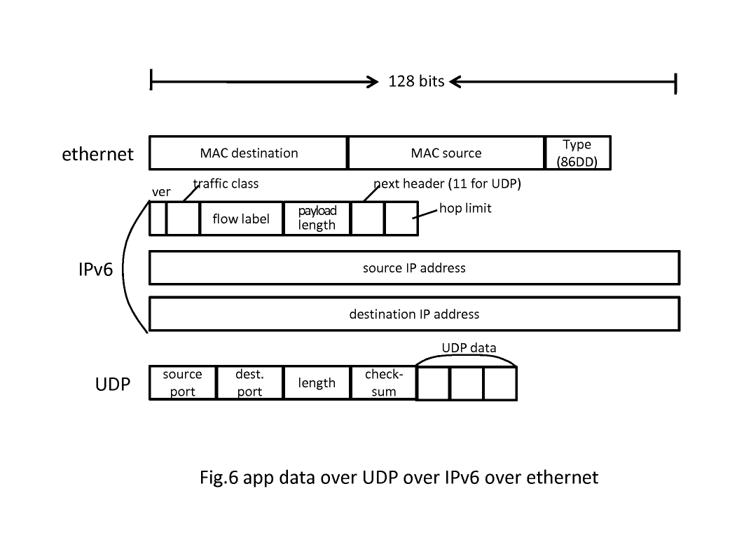

Before discussing configuration flow, I have to mention that network layer FSM 330 keeps capturing periodic router advertisements 419 and outputs the captured network parameters from router advertisements to configuration unit 360. Such network parameters include subnet prefix, prefix valid lifetime and hop limit. MTU size parameter is not needed because embodiments normally use frames much shorter than MTU size. Router advertisement is communicated as ICMPv6 protocol run over IPv6 over ethernet. Out of the MAC and PHY 310/410r, the frame structure is depicted as FIG. 5 with following field values (width of each field on FIGS. 5 and 6 is drawn proportional to number of bits; Ethernet FCS is not included because it is removed by MAC and PHY 310):

Router Advertisement (RX)
ethernet

| | |
|---|---|
| MAC destination | FF:FF:FF:FF:FF:FF (broadcast) |
| MAC source | MAC address of the router; don't care |
| Type | 86DD (IPv6) |

IPv6

| | |
|---|---|
| ver | 6 |
| traffic class | 0 |
| flow label | 0 |
| payload length | proper length value |
| next header | 3A (ICMPv6) |
| hop limit | FF; don't care |
| source IP address | link-local address of the router interface; don't care |
| destination IP address | ff02::1 (all-node multicast address) |

ICMPv6

| | |
|---|---|
| type | 86 (134 in decimal) |
| code | 0 |
| checksum | valid checksum |

The hop limit is in a fixed location in router advertisement body, while subnet prefix and prefix valid lifetime are in the option field. As per RFC4861, option fields can be delimitated by length parameters in the options. I can extract these network parameters and outputs them to configuration unit 360, where a copy of them is registered.

In the configuration unit 360, when global IPv6 address is not defined or prefix valid lifetime is timeout, the device need to configure or reconfigure itself. It waits for valid registered network parameters, forms its global IP address by combining the subnet prefix (from above) and modified EUI-64 MAC address according to IPv6 standard. Then the configuration unit instructs the link layer to send a neighbor advertisement frame with newly formed global IP address. The configuration unit 360 also set the timer for prefix lease timeout. The neighbor advertisement frame has the same structure as FIG. 5 with following field values:

Neighbor Advertisement (TX)
Ethernet

| | |
|---|---|
| MAC destination | FF:FF:FF:FF:FF:FF (broadcast) |
| MAC source | MAC address of the device |
| Type | 86DD (IPv6) |

IPv6

| | |
|---|---|
| ver | 6 |
| traffic class | 0 |
| flow label | 0 |
| payload length | proper length value |
| next header | 3A (ICMPv6) |
| hop limit | FF |
| source IP address | the newly formed global IP address of the interface |
| destination IP address | ff02::1 (all-node multicast address) |

ICMPv6

| | |
|---|---|
| type | 88 (136 in decimal) |
| code | 0 |
| checksum | valid checksum |

The purpose of this neighbor advertisement frame is to notify router on the link existence of this device. So after a while, the router adds or updates mapping of the device's IPv6 address vs. link layer address, and messages from other hosts on the whole Internet are deliverable to this device by the router. The device 399 is done with configuration and can go back to normal data flow. The clock to configuration unit 360 can be turned off to further save power.

Normal Data Flow 460

In this packet flow, I assume the device 399 won't initiate any action (it is a dump device anyway and is best only to initiate about being configured). Whenever a remote host wants to communicate with this device 399, the remote host sends a frame in UDP to ask the device to do something. The frame is delivered to the device through the router (since above configuration flow has finished). The device 399 (or applications on the device 429) does the work dictated by the remote host and immediately returns the very same data portion of the frame to acknowledge receiving the frame. I can separate the processing above MAC and PHY 310 into following 3 steps.

### 1. Upper Link 320/Network 330/Transport 340 Layer Units in RX

When the device 399 receives a frame from the router, the frame must pass link address and FCS checking in MAC and PHY unit 310/410r. The valid data frame coming out of MAC and PHY unit 310/410r is application data over UDP over IPv6 over ethernet, like FIG. 6. If any required field is incorrect, the frame is just dropped 426. Some of the fields are kept temporarily because later application layer 350/429 will return a frame back with those field values.

application data (RX)
ethernet

| | |
|---|---|
| MAC destination | MAC address of the device |
| MAC source | MAC address of the router; kept but don't care |
| type | 86DD (IPv6) |

IPv6

| | |
|---|---|
| ver | 6 |
| traffic class | 0 |
| flow label | 0 |
| payload length | proper length value |
| next header | 17 (UDP) |
| hop limit | xx (don't care) |
| source IP address | global IP address of the remote host; kept but |
| | don't care |
| destination IP address | global IP address of the device |

UDP

| | |
|---|---|
| source port | source port value; kept but don't care |
| destination port | xx (don't care) |
| length | valid values |
| checksum | valid checksum |
| data | sequence number, command, data; 8-bit each |

2. Application Layer 350 and Providing Applications 429

Here I suppose any remote host wanting to communicate to this device 399 will send an 8-bit sequence number, 8-bit command and 8-bit data first. The 8-bit sequence number is used by the remote host to detect lost packets. The 8-bit command may, for example, indicate the 8-bit data is for desire temperature setting for an air conditioner the device 399 hooked to. Upon receiving this frame, the device 399 decodes the command, finds the data is for some of the pins, outputs the data to the pins, and sets the air conditioner temperature setting 429. This way an air conditioner temperature can be controlled by a remote host across the Internet. Then the application processing unit 355 sends the same data portion of the frame (8-bit sequence number, 8-bit command, and 8-bit data) to transport layer unit 340 in TX direction immediately.

3. Transport 340/Network 330/Upper Link 320 Layer Units in TX

In this step the new frame is constructed by swapping destination MAC address/IP address/port number with source MAC address/IP address/port number in original frame, respectively. This way the replied frame will be delivered to the router, to the original sender, then to the original process. The hop limit field of IPv6 was from router advertisement during configuration flow 450. Other fields are fixed values or calculable values (like checksum, payload length). After receiving response from the device, the remote host is sure the device 399 has received the frame and accordingly set the temperature.

Conclusion

Note that in above example, because the communication path is unreliable, packets may be lost. But that doesn't matter. The remote host can just keep sending frames until it receives an acknowledgement. The remote host is also smart enough to judge the packet loss condition from sequence numbers returned.

The implementation of those frame receivers and transmitters can be in the form of FIFO (First-In First-Out) structure. For RX frame, when complete frame is received in FIFO, each field is delimitated by fixed position or length field and validity for various required fields (like addresses, checksum, type, next header, etc) are checked. Don't-care fields can be ignored. Any frame that does not pass the checking is dropped. For TX, each field is generated into FIFO. When complete frame is finished, the FIFO is open and outputs to MAC and PHY (310/410t).

Although above I suppose leveraging an off-the-shelf MAC & PHY, it is actually common part even software method is used. So just adding a little logic like above, it provides IoT connectivity. It will use less power than software method, since all the transistor switchings are “necessary”; no unnecessary switchings related to those components inside a processor. A lot of features of such off-the-shelf MAC & PHY can be deleted for this special purpose IoT end device, like extra interfaces, internal storage, error handling etc. So it can further be simplified and becomes very cost-effective.

The final result is low cost low power devices that can be sprinkled along ethernet or power (for ethernet-over-power) cables, to monitor network status, to monitor or control power delivery, to control appliances, or for environmental sensing appliances. Since the power requirement is very low, it could also potentially get power from harvesting signal swing energy on regular un-powered ethernet network.

### DETAIL DESCRIPTION

### Second Embodiment

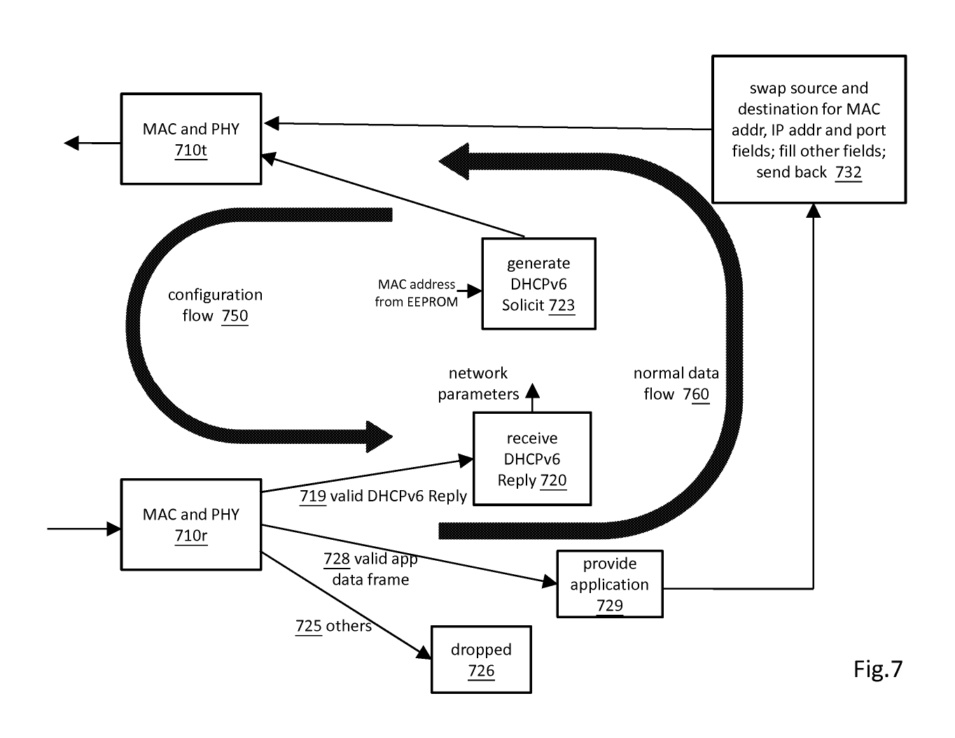

In this Second Embodiment I assume the same setup as First Embodiment but DHCPv6 rapid commit is used for the configuration flow. DHCPv6 rapid commit needs exchanging just two messages. During configuration flow, the device first sends a DHCP Solicit, then after a while it receives a DHCP Reply from DHCP server. The DHCP Reply contains network parameters (like global IP address, lease time, hop limit). The device configures itself with those parameters and finishes configuration flow. Then the data flow starts like First Embodiment. The packet flow chart is shown as FIG. 7. DHCPv6 Solicit and Reply are carried by UDP, just like application data in FIG. 6 (except UDP data is wider). Values of the fields are as below (see also RFC 3315):

DHCP Solicit (TX)
ethernet

| | |
|---|---|
| MAC destination | FF:FF:FF:FF:FF:FF (broadcast) |
| MAC source | MAC address of the device |
| type | 86DD (IPv6) |

IPv6

| | |
|---|---|
| ver | 6 |
| traffic class | 0 |
| flow label | 0 |
| payload length | proper length value |
| next header | 17 (UDP) |
| hop limit | 1 |
| source IP address | link-local address |
| destination IP address | FF02::1:2 (All_DHCP_Relay_Agents_and_Servers |
| | multicast address) |

UDP

| | |
|---|---|
| source port | 222 (546 decimal) |
| destination port | 223 (547 decimal) |
| length | valid values |
| checksum | valid checksum |
| data | set msg-type = 1 and rapid commit; set transaction- |
| | id and Client Identifier for identification |

−DHCP Reply (RX)
ethernet

| | |
|---|---|
| MAC destination | MAC address of the device |
| MAC source | MAC address of the DHCP server (don't care) |
| type | 86DD (IPv6) |

IPv6

| | |
|---|---|
| ver | 6 |
| traffic class | 0 |
| flow label | 0 |
| payload length | proper length value |
| next header | 17 (UDP) |
| hop limit | FF; don't care |
| source IP address | link-local of DHCP server; don't care |
| destination IP address | link-local of this device |

UDP

| | |
|---|---|
| source port | 223 (547 decimal) |
| destination port | 222 (546 decimal) |
| length | valid value |
| checksum | valid checksum |
| data | msg-type = 7 and rapid commit; Client Identifier |
| | matches previously set, extract IP address, lease |
| | time, hop limit |

The normal data flow is similar to First Embodiment. But in this embodiment I suppose application is sensor data needing to send back. The remote host sends sequence number, command, data, 8-bit each, as before. But the command indicates it is sensor data needing to be retrieved. The application processing unit 355 places the sensor data in the data field and send the sequence number, command, and new data back as First Embodiment.

### DETAIL DESCRIPTION

### Third Embodiment

In this embodiment, I assume IEEE 802.15.4 standard as physical and link layers. IEEE 802.15.4 is a wireless network. As one of the main design goals for IEEE 802.15.4 is low cost, digital operations are not as complicated and can switch from processor control to FSM fairly easily.

Jon T. Adams of Freescale Semiconductor, Inc mentioned in his year 2005 article “An Introduction to IEEE STD 802.15.4” that “MAC could be implemented in a state machine or . . . . ” (However, still nothing was mentioned about higher layers). If such product is about available, the introduction of this embodiment will be very much like the previous sections with a little more controls for lower layers. But to fulfill the requirements in 35 U.S.C. 112, here I provide a possible embodiment of the invention with some physical and link layer controls.

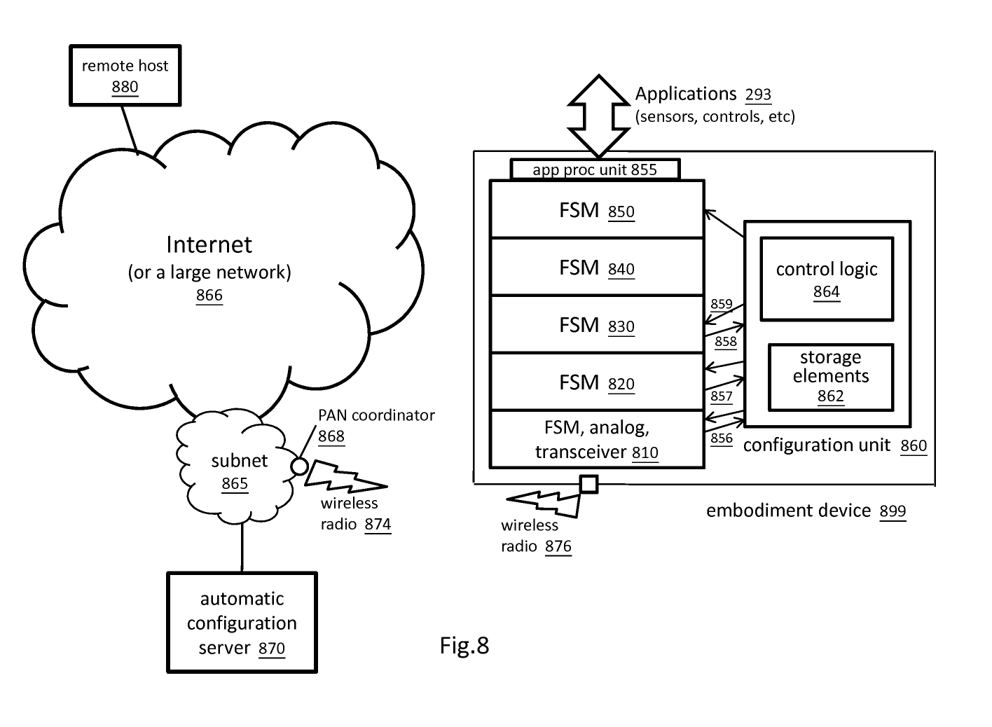

FIG. 8 shows such embodiment device 899 and its relationship to the whole network, including Internet or a large network 866, a subnet 865, and an automatic configuration server 870 on the subnet 865. The embodiment device 899 is a Reduced-Function Device (RFD) in the terminology of IEEE 802.15.4. It needs to associate with a PAN (Personal Area Network) with a PAN ID started by a PAN coordinator 868. In addition to PAN association, if the device requires Internet connection capability, it needs to obtain network parameters for Internet. I also suppose a proprietary automatic configuration protocol in network layer is used. Below are introductions for each unit.

0. Configuration Unit 860

In this embodiment, only a proprietary automatic configuration protocol is used and it runs in network layer 830, as indicated by 858/859. But if any layer other than network layer requires some programmable parameters, this proprietary automatic configuration protocol can be used for such parameters.

But before a protocol in a layer can start communicating, all underlying layers need to be configuration-free or configuration-done. This wireless embodiment requires configurations in link and physical layers before configuration flow can start. In the control logic 864, I would provide logic to scan through all frequency channels to find strongest signal, associate to that channel number and PAN ID. Nowadays people hate to connect wires even for simple USB connectors. This way user can place the device near PAN coordinator so it receives strongest signal from the coordinator for configuration flow, finish the configuration flow, and the device can be placed elsewhere; everything is done wirelessly. The automatic configuration protocol may even program new PAN ID and frequency channel number (most likely they are the same as for the configuration flow but they can be different values). If the wrong PAN is associated during configuration flow, a factory reset will do the trick.

So I need signal strength and PAN ID feedback from physical layer 810 and link layer 820, as indicated by arrows 856 and 857. Other embodiments may use other methods to decide which PAN to associate with for the configuration flow; for example, PAN with certain patterns or PAN ID with certain keywords, etc.

I also assume the device need to talk to just one automatic configuration server 870 to get all its network parameters, i.e., the automatic configuration server 870 has full knowledge of all the network parameters for all layers the device 899 needs. One example of memory map for the storage elements 862 can be like below:

| | |
|---|---|
| 0000-000F | Device Identifier (not writable) |
| 0010-001F | Encryption and Protection Keys |
| | (optional; not writable for reconfig) |
| 0100-010F | PAN ID (not writable for reconfig) |
| 0110-011F | phy channel number (not writable for reconfig) |
| 0200-020F | Global IP address for this device |
| 0210-021F | other network layer parameters |
| | (hop limit, IP address lease time) |
| 0300-030F | Application Layer parameters |

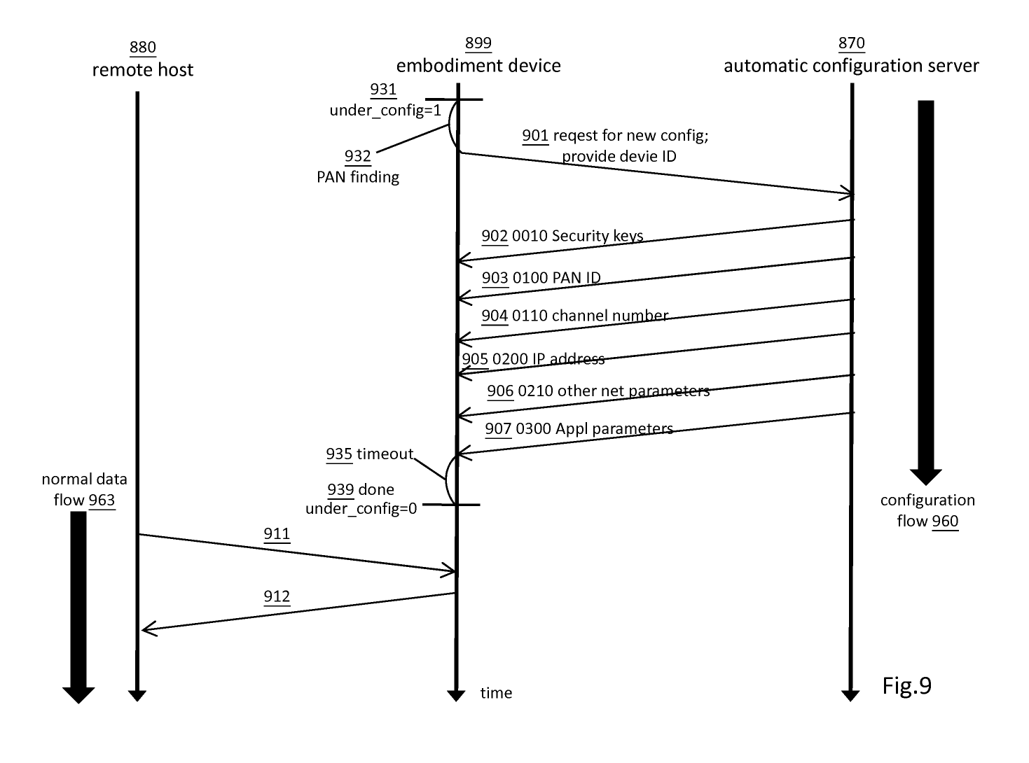

When the device 899 is newly connecting to a network 866/865, a FSM in control logic 864 inside the configuration unit 860 detects this situation and sets an under_config bit (also see 931 in FIG. 9). When this bit is set, all communications above link layer 820 are “hijacked” by the configuration unit 860 to form configuration flow, until configuration is done and this bit is unset 939.

As mentioned above, the control logic then finds the PAN ID and channel number of the strongest signal for link layer 820 and physical layer 810 to associate with. It uses passive scan to scan through all the allowable channels. In each channel, it scans through each PAN and uses PHY to detect the signal strength. It compares the signal strength value with the registered value. If the newly-scanned strength value is larger than the registered value, it replaces the registered PAN ID, channel number and strength value with this new value set. After completing passing scan, the registered value set is for the strongest PAN and the device associate with that PAN.

Then the control logic 864 generates a packet with a request-for-new-configuration indicator and its Device Identifier (address 0000) with multicast destination address to reach the automatic configuration server 870. It encapsulates that packet as a network layer frame and gives the packet to link layer FSM 820 for link layer processing (including adding link layer broadcast address). Then, the link layer FSM 820 gives the packet to physical layer unit 810 for physical layer processing and physical layer unit 810 delivers the packet to the physical medium. That starts the proprietary automatic configuration protocol, as depicted in FIG. 9 as 901.

Hopefully, the automatic configuration server 870 receives the packet and finds itself addressed. After some processing, the automatic configuration server 870 prepares a set of network parameters for the device 899. The automatic configuration server 870 sends back the network parameters to the device 899 in several packets using device's 899 Device Identifier as destination address and link-local address (or broadcast or multicast address) as IP address.

For simplicity, I assume in each packet the automatic configuration server 870 sends back include two bytes for the address of the storage elements 862, and the rest 16 data bytes for data written to the storage elements 862 starting at that storage elements 862 address. These packets are depicted as packet 902 to packet 907 in FIG. 9.

Then, when those packets are received by the device 899, they are processed by physical 810 and link 820 layers before packet data portion are sent to the configuration unit 860. The control logic 864 inside the configuration unit 860 extracts data and address for storage elements. The data are written to the specified address of the storage elements 862. After a timeout value without receiving packet, the device 899 knows the configuration process is done and unsets under_config bit. Then, the data communication paths are back to normal flows (in the order of 810/820/830/840/850 and 850/840/830/820/810) and the device 899 can start providing applications for remote hosts 880. The clock signal to the configuration unit 860 can be turned off to further save power during normal data operation.

Above is configuration for a device newly connected to the network. Some similar process can be used for re-configuration due to IP address lease timeout, remote host request re-configuration, etc. But Encryption Key, PAN ID and phy channel number are not overwritten. This is done by sending a request-for-reconfig indicator, instead of request-for-new-configuration indicator.

Here for normal data flow I assume simple security mechanism is used with Encryption and Protection Keys. Encryption Key is used for encrypting data portion of a link layer frame. Protection key is in data portion of a link layer frame and needs to be matched exactly on RX packet for passing that packet above link layer 820. These keys are programmed during configuration flow.

1. Physical Layer 810

This layer consists of RF transceiver, analog circuit and digital circuit. It does mux/demux basically and the radio may be turned off during off-duty by phy control logic. There may be also some controls for link quality indicators. During normal data flow, the channel number is from address 0110 of the storage elements 862. During configuration flow, the channel number is controlled by control logic 864 as mentioned.

2. Link Layer 820

This layer does mux/demux basically and provides frame validation. During normal data flow, the PAN ID is from address 0100 of the storage elements 862. During configuration flow, the PAN ID is chosen by control logic 863 as mentioned.

There are many options for IEEE 802.15.4 link layers, like channel access mechanism (ALOHA or CSMA-CA), slotted or unslotted, guaranteed time slot. Fortunately, for this RFD I just need to choose one particular type.

There is also acknowledged frame delivery, using ARQ. But link layer ARQ is much easier than TCP end-to-end reliability. It is handled right in link layer (doesn't need to go through other layers) and has no pipelining function. In 802.15.4, the sequence numbers are only 8-bit. The link layer reliability in IEEE 802.15.4 can also be independently optional in each of communication directions. I currently contemplate implementing acknowledged frame delivery in both ways, but even without any acknowledged frame delivery, the remote host is supposed to be “smart” and should be able to handle such condition; examples are like resending after first timeout value, assuming the device is lost after second timeout value, etc.

The encryption and protection keys are implemented in this layer like above mentioned.

3. Network Layer 830

For Internet “middle” devices or routers, the routing protocols in this layer are highly complicated. But end devices don't need to care about such. In this layer end devices only need to implement IP, which has version 4 and version 6 but they are almost about mux/demux with data integrity check. The global IP address for this device is in storage elements address 0200. Another required network parameter is “hop limit” from storage elements address 0210. In RX direction the destination IP address of RX packet need to be the same as this global IP address or broadcast/multicast addresses so packets can be properly addressed. It also keeps the recently received source and destination IP addresses; so when application layer replies, it can find correct IP address values.

4. Transport Layer 840

If TCP were used, this layer would have been highly complicated. But I will just use UDP, which is all about mux/demux with data integrity check. RX destination port number is don't-care since this device doesn't have processes.

5. Application Layer 850

For traditional Internet devices, applications are encapsulated in some forms of communication protocols in application layer. These are like HTML, TELNET, FTP, etc. But for IoT devices, applications may be just one bit data representing on- or off-status, or 8-bit of sensor data, for examples. They are placed right in the data portion of a lower protocol and such placing, though simple, is still considered communication protocols in this application.

6. Application Processing Unit 855

In this embodiment the remote host sends an 8-bit sequence number, 8-bit command and 8-bit command data. Like First Embodiment, the device returns the same data portion back. However, I suppose the device won't react to the command until explicitly receive another GO command. This way I can have something close to TCP end-to-end reliability without taxing too much on the hardware.

In the storage elements address 0300-030F I reserve some bytes for application layer parameters. They can be used, for example, selecting specific sensors, specific applications, or specific options of an application.

7. Conclusion

Without TCP, each unit is reasonably feasible. Integrating all the functions into a single chip can be done with reasonable effort. With the same battery pack and the same duty as current prior art devices, this embodiment can operate a bit longer, since only necessary transistors are being switched. It will also be cheap enough to be placed everywhere to connect sensors or controlling alliances to Internet.

### DETAIL DESCRIPTION

### Other Ramifications and Conclusion

In conclusion, embodiments of the invention provide a processorless state-machine based system-on-chip solution for a network device to transfer data across Internet or a large network. The data communication part of the network device can be compromised to use much simpler protocols. However, an Internet device requires configurations to communicate properly. Such configurations in a commercially available device need to come from other node on the network by an automatic configuration protocol and such configuration communication part has to be implemented processorlessly too. The overall result is a chip for an Internet device that saves power and cost by eliminating components for a processor system. It is particularly useful in Internet-of-Thing applications and for hooking up appliances and sensors to Internet.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

For example, standardized automatic configuration protocols can be regular DHCPv4, DHCPv4 rapid commit, regular DHCPv6 regular, DHCPv6 rapid commit, IPv6 Neighbor Discovery protocol suites, or any simplified, modified or future versions.

When a proprietary automatic configuration protocol is used, the various parameters in the Third Embodiment are for illustration purpose; other embodiments may use different parameters for controlling different features. The protocol may provide data written to storage elements without explicitly providing address for the data. All the parameter data may be conveyed in a single packet or different number of packets.

The proprietary automatic configuration protocol can be in physical or link layer, so no lower layers need to be configured before automatic configuration starts, as long as there is no channel access problem.

In some situations, the device can generate network parameters itself by using its localized parameters (for example, link address, current time, etc) with some manipulations (for example, pseudo-random coding). However, even in such situation some interaction with other hosts outside of the device is still necessary, to make sure such parameters are fine to use or to notify other nodes on the network; otherwise such parameters may jeopardize network stability or become useless. Such interaction belongs to automatic configuration protocols.

In some embodiments the servers may send out configuration information at certain time intervals, letting devices to use the information. The device using this information still needs to get approval or confirmation by other nodes. The whole process uses protocol(s) that belongs to the automatic configuration protocols.

Although in the drawings, the host providing network parameters is shown as a standalone machine, it may just be a combination of functions inside a particular network node or nodes.

The automatic configuration server may obtain configuration parameters elsewhere. It is just the party the device communicating to for requesting parameters.

In case of re-configuration, the protocol may be just an indicator of whether previous parameters are OK to use.

In above Embodiments, swapping source and destination MAC address/IP address/port number is just for illustration. Actual implementation may use other calculated addresses or port numbers.

ICMP (ICMPv4 for IPv4 and ICMPv6 for IPv6) can be used for transporting data substituting for UDP. Some may use TCP without reliability feature too; for example, one can establish a TCP channel disabling retransmit or acknowledge mechanism.

There can be a capability page so routers or other nodes on the Internet can learn the capability of this device. The capability page may be stored in the storage elements and be returned by a command.

There can be add-on on top on embodiments of the invention like data integrity mechanism, reliable mechanism, encryption mechanism, security mechanism, periodic status reporting, live signaling, selectable function from dipswitch, etc.

In above Embodiments I suppose the device not initiate any action except being configured. It can actually keep first-hop router address and is able to provide service actively to a known address.

Accordingly, the scope should be determined not by the embodiments illustrated, but by the appended claims and their legal equivalents. claim

What is claimed is:

1. A chip for a device communicating on a network over a physical medium, comprising:
a. a finite state machine for handling all digital operations of all communication protocols for said device;
b. a configuration unit that determines network parameters with information from other device on said network through at least one communication protocol and said configuration unit configures said device with said network parameters; and
c. none of said communication protocols provides end-to-end reliability, whereby said network can have millions of devices and said device can communicating on said network and substantially save power and cost.

2. The chip of claim 1, further including a finite state machine or digital circuit for providing all applications.

3. The chip of claim 1, wherein said chip is made of silicon as substrate, said chip is designed by ASIC method, and said device is a network end device.

4. The chip of claim 3, further including a finite state machine or digital circuit for providing all applications.

5. The chip of claim 3, wherein said communication protocols do not include Transmission Control Protocol.

6. The chip of claim 1, wherein said communication protocols do not include Transmission Control Protocol.

7. The chip of claim 1, wherein said communication protocols do not include Transmission Control Protocol, said device is a network end device, and further including means for providing applications without using a processor.

8. The chip of claim 1, wherein said communication protocols do not include Transmission Control Protocol, said chip is made of silicon as substrate, said chip is designed by ASIC method, said physical medium is air, vacuum or water, said device is a network end device, and further including a finite state machine or digital circuit for providing all applications.

9. The chip of claim 1, wherein said network parameters include network layer address.

10. A method of communicating on a network for a network end device over a physical medium, comprising:
a. handling all digital operations of all communication protocols by a finite state machine on a single chip; and
b. configuring said device with network parameters determined by information from other device on said network through at least one communication protocol, whereby said network can have millions of devices and said device can communicating on said network and substantially save power and cost.

11. The method of claim 10, further including using a finite state machine to provide all applications.

12. The method of claim 10, wherein said single chip is made of silicon as substrate and designed by ASIC method.

13. The method of claim 10, wherein said physical medium is air, vacuum or water, further including means for associating to the strongest signal for new configuration.

14. The method of claim 10, further including using UDP or ICMP protocol for transporting application data.

15. The method of claim 10, further including using UDP or ICMP protocol for transporting application data and using a finite state machine to provide all applications.

16. A chip for a network end device communicating on a network over a physical medium, comprising:
a. means for processing applications and all digital operations of all communication protocols for said device without a processor; and
b. said communication protocols do not include Transmission Control Protocol, whereby said network can have millions of devices and said device can communicating on said network and substantially save power and cost.

17. The chip of claim 16, further including means for configuring said device with network parameters determined by information from other device on said network through at least one automatic configuration protocol.

18. The chip of claim 17, wherein said physical medium is air, vacuum or water and said means for configuring further including means for associating to the strongest signal for new configuration.

19. The chip of claim 16, further including means for configuring said device with network parameters determined by information from other device on said network through one automatic configuration protocol and said automatic configuration protocol requires said device to transmit only one packet.

20. The chip of claim 16, wherein said physical medium is air, vacuum or water, further including means for associating the strongest signal for new configuration.
